(19) United States
(12) Patent Application Publication
(10) Pub. No.: US 2003/0227494 A1
(43) Pub. Date: Dec. 11, 2003

(54) Marking apparatus comprising at least one guiding member and at least one drive carriage

(76) Inventor: Marcel Therond, Rillieux La Pape (FR)

Correspondence Address: DOWELL & DOWELL PC, SUITE 309, 1215 JEFFERSON DAVIS HIGHWAY, ARLINGTON, VA, 22202

(21) Appl. No.: 10/454,579

(22) Filed: Jun. 5, 2003

(30) Foreign Application Priority Data
Jun. 6, 2002 (FR) 0206972

(51) Int. Cl. B43L 13/00

(52) U.S. Cl. 346/141; 33/18.1

(57) ABSTRACT

This invention relates to a marking apparatus which comprises a frame, a marking tool and at least one drive carriage, mounted to slide with respect to at least two guiding members. A first guiding member is housed in an opening made in the carriage, a slide bearing comprising a sheath formed from a resin polymerizable to the solid state being interposed between this first guiding member and the opposite walls of the corresponding opening, while means are provided for holding the other guiding member with respect to the carriage, while allowing a transverse clearance between the carriage and the other guiding member, the holding means defining a volume for receiving the other guiding member which opens out on one side of the carriage.

### FIELD OF THE INVENTION

The present invention relates to a marking apparatus comprising at least one guiding member and at least one drive carriage.

Within the meaning of the invention, the generic term marking apparatus denotes any apparatus adapted to make a pattern on the surface of a workpiece, whether by impression, deformation or removal of matter from this surface.

### BACKGROUND OF THE INVENTION

As is known, a marking apparatus comprises a frame supporting a mechanism for driving a marking tool, which may in particular be a pneumatic stylus or an engraving head. This drive mechanism conventionally comprises an element, fixed with respect to the frame, provided with flanges on which two guide bars are disposed. A first drive carriage is mounted to slide on the latter and is itself provided with two additional bars which are perpendicular to the afore-mentioned first pair of bars and are intended to receive a second drive carriage on which the marking tool is fastened.

Thanks to the use of this so-called “crossed carriage” drive mechanism, the marking tool is adapted to move in two directions perpendicular to each other, with respect to the frame.

The method of mounting each carriage on the guide bars which receive it consists firstly in making at least one bore in this carriage, then in fitting in each bore at least one self-lubricating bearing, for example by gluing or by force-fit. This assembly thus constituted is then mounted to slide on the guide bars.

However, this known method of assembly presents certain drawbacks. In effect, it is accompanied by an extremely meticulous operation of positioning of this carriage with respect to the self-lubricating bearing, which involves a particularly precise machining of the afore-mentioned bores. This method therefore involves considerable time and high manufacturing costs.

In order to overcome these drawbacks, French Patent FR-A-2 805 867 proposed to make such a bearing from a sheath formed by a resin polymerizable to the solid state. This sheath in that case extends between, on the one hand, the inner walls of the afore-mentioned bore and, on the other hand, the outer wall of the guiding member or a ring, added around this outer wall.

Such a solution is advantageous, insofar as it is considerably simpler and more rapid to carry out than the solution employing the glued or force-fit self-lubricating bearing.

Furthermore, French Patent FR-A-2 056 197 describes a support and guiding element for the slide of sliding workpieces on shafts, in which a support plate may be guided along two shafts. One of these shafts is in addition supported and guided in an elastic slide bearing, for example made of a thermoplastics material, which thus allows an elastic deviation.

Under these conditions, the present invention aims at proposing a marking apparatus offering further increased simplicity, and involving manufacturing costs which are further reduced with respect to the teaching of FR-A-2 805 867, concerning the positioning of the drive carriages on their guiding members.

### SUMMARY OF THE INVENTION

To that end, the invention relates to a marking apparatus, comprising a frame, a marking tool and at least one carriage for driving this marking tool, the or each carriage being mounted to slide with respect to at least two guiding members, characterized in that a first guiding member is housed in an opening made in the carriage, a slide bearing comprising a sheath formed from a resin polymerizable to the solid state being interposed between this first guiding member and the opposite walls of the corresponding opening, while holding means are provided, adapted to maintain the or each other guiding member with respect to the carriage, while allowing a transverse clearance (arrow A) between the carriage and the or each other guiding member, the holding means defining a volume for receiving the or each other guiding member, this receiving volume opening out on one side of the carriage.

Other characteristics of the invention form the subject matter of the accompanying sub-claims.

### BRIEF DESCRIPTION OF THE DRAWINGS

The invention will be more readily understood on reading the following description given by way of non-limiting example with reference to the accompanying drawings, in which:

FIG. 1 is a view in perspective of a marking apparatus according to the invention.

FIG. 2 is a front view, on a larger scale, illustrating the assembly of a drive carriage of the marking apparatus of FIG. 1, on two guiding members.

FIG. 3 is a view in section along line III-III, shown in FIG. 2, and

FIG. 4 is a partial front view, similar to FIG. 2, illustrating a first variant embodiment of the drive carriage.

### DESCRIPTION OF PREFERRED EMBODIMENTS

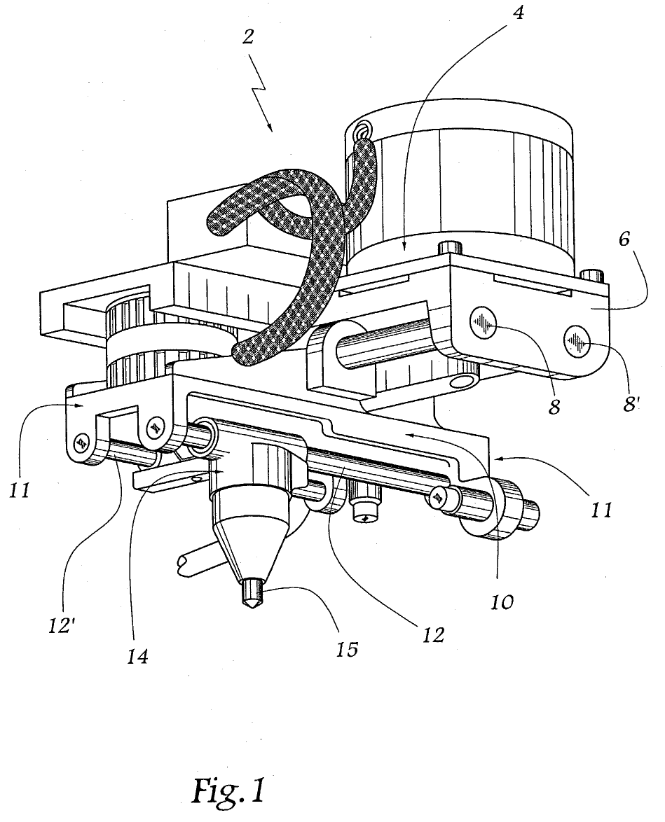

Referring now to the drawings, the marking apparatus shown in FIG. 1 and generally designated by reference 2, comprises, in manner known per se, a fixed frame 4 presenting two opposite flanges 6. These latter support two bars 8 and 8′ which constitute guiding members for the displacement of a first carriage 10 along the principal axis of these bars.

This first drive carriage 10 is provided with two opposite flanges 11 between which two additional guide bars 12 and 12′ extend, the two pairs of bars 8, 8′, 12 and 12′ being disposed substantially at right angles.

The bars 12 and 12′ ensure guiding of a second carriage 14, on which is connected a marking tool 15 which may for example be a pneumatic stylus or an engraving head.

These two carriages 10, 14 form a mechanism for driving the marking apparatus 2, and ensure the positioning of the marking tool in two directions at right angles to each other. The respective setting in motion of the two carriages 10, 14 is ensured in manner known per se, via electric motors (not shown).

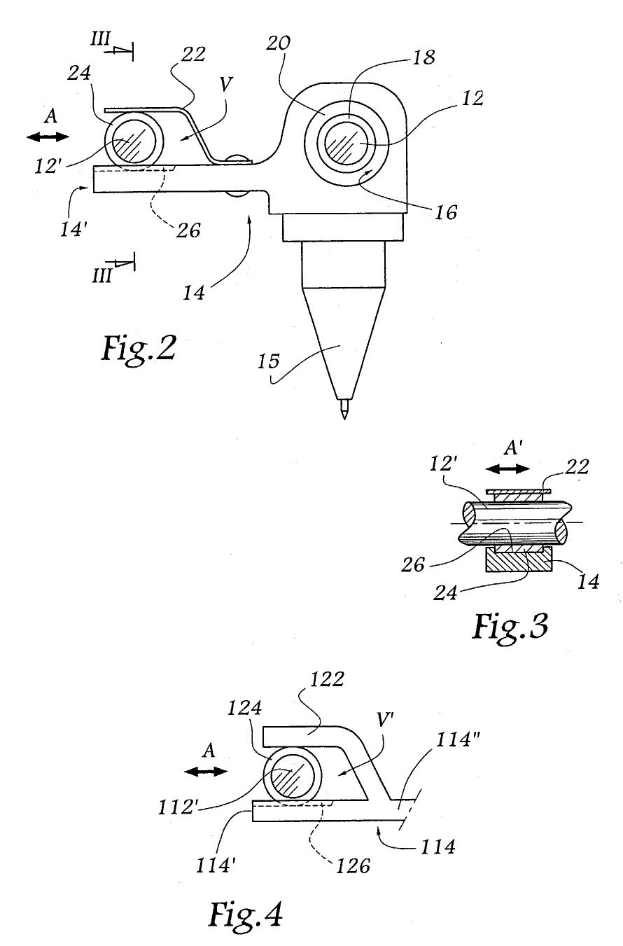

The assembly of each drive carriage on the guide bars will be explained with reference to FIGS. 2 and 3. In the latter, reference will solely be made to the assembly of the carriage 14 on the bars 12 and 12′, it being understood that the carriage 10 is assembled on the bars 8 and 8′ in similar manner.

FIG. 2 partially illustrates the carriage 14, mounted on the two guide bars 12 and 12′.

This carriage has a substantially cylindrical through opening, generally designated by reference 16, hollowed out therein. This opening receives a ring 18, disposed around the first bar 8, as well as a sheath 20, interposed between the opposite walls of the ring 18 and of the opening 16.

Such a sheath 20 is made by polymerization of a resin, in accordance with the teaching of French Patent FR-A-805 867. With the ring 18, it thus forms a bearing of the carriage 14.

By way of variant, such a bearing may be constituted solely by this resin sheath 20, directly interposed between the opposite walls of the opening 16 and of the bar 8. In this form of embodiment, likewise described in FR-A-2 805 867, the ring 18 is absent.

Furthermore, a blade 22 forming spring, which is fixed on the carriage 14, defines with the latter a lower volume V for receiving the other guide bar 12′. It should be noted that this volume V is open transversely, at one of its ends.

As shown in FIG. 2, the bar 12′ is surrounded by another ring 24, similar to ring 18. This ring 24 is housed in a groove 26, made on the upper surface of the carriage 14, opposite the spring blade 22.

It should be noted that this groove 26, which opens out on the side 14′ of the carriage, presents transverse dimensions greater than those of the ring 24. Consequently, there exists a possibility of transverse clearance in direction A between, on the one hand, the carriage 14 and, on the other hand, the ring 24 and therefore the second bar 12′.

On the contrary, as shown more precisely in FIG. 3, the groove 26 presents longitudinal dimensions similar to that of the ring 24. In this way, the latter is connected in translation with respect to the carriage 14, in the principal direction A′ of the bar 12′.

In service, the carriage 14 is made to move along the two bars 12 and 12′. If the latter are not strictly parallel, the ring 24 is still free to move along the second bar 12′, while not necessarily remaining at a constant distance from the first bar 12.

Furthermore, the spring blade 22 applies the ring 24 against the bottom of the groove 26. It should be noted that the stiffness of this spring blade is appropriate as a function of the efforts induced by the marking tool 15, and as a function of the power of the motorization means.

FIG. 4 illustrates a variant embodiment of the invention. In this Figure, the mechanical elements similar to those of FIGS. 1 to 3 are given the same reference numbers, increased by 100.

According to this variant, the spring blade 22 is eliminated. To that end, the carriage 114 is provided with an arm 122 forming, with the body 114″ of this carriage, a fork in the inner volume V′ of which the bar 112′ and the ring 124 are received.

By way of additional variant (not shown), the two ends of each of the guide bars 8, 8′, 12 and 12′ may be fixed on corresponding raised edges, in accordance with the teaching of EP-A-0 915 260, i.e. via a polymerizable resin.

The invention makes it possible to attain the objects set forth hereinabove.

In effect, in the prior art described in FR-A-2 805 867, it is necessary to arrange each pair of guiding members to be strictly parallel. In effect, if such were not the case, the carriage would be likely to be blocked, during its slide with respect to these guiding members.

On the contrary, in the marking apparatus according to the invention, it is not compulsory to arrange the guiding members to be strictly parallel. Consequently, the corresponding method of manufacture is simplified, this ensuring a reduction of the manufacturing costs of this marking apparatus.

In this respect, it should be noted that possible defects in parallelism between the guiding members are compensated by the possibility of transverse clearance offered to the carriage. In this way, the latter is able to slide laterally with respect to one of the bars, during its displacement, which avoids any risk of jamming.

Finally, the presence of a volume for reception opening out on a side of the carriage is advantageous with respect to the teaching of FR-A-2 056 197, employing an elastic bearing. In effect, this arrangement allows the carriages 10 and 14 to be assembled or dismantled, even if the bars 12′ and 112′ and the bearings 24 and 124 are in place. All proportions being equal, this allows a greater defect in parallelism between the guide bars. Finally, a defect in parallelism does not cause elastic deformation, contrary to what happens with the section 14 described in FR-A-2 056 197. Consequently, thanks to the invention, there is no generation of parasitic effort on the bearings.

What is claimed is:

1. Marking apparatus, comprising a frame, a marking tool and at least one carriage for driving this marking tool, the or each carriage being mounted to slide with respect to at least two guiding members,
wherein a first guiding member is housed in an opening made in the carriage, a slide bearing comprising a sheath formed from a resin polymerizable to the solid state being interposed between this first guiding member and the opposite walls of the corresponding opening, while holding means are provided, adapted to maintain the or each other guiding member with respect to the carriage, while allowing a transverse clearance between the carriage and the or each other guiding member, the holding means defining a volume for receiving the or each other guiding member, this receiving volume opening out on one side of the carriage.

2. The marking apparatus of claim 1, wherein the holding means are elastic holding means.

3. The marking apparatus of claim 1, wherein the holding means are added on the carriage.

4. The marking apparatus of claim 2, wherein the added holding means comprise at least one elastic element, in particular a spring blade.

5. The marking apparatus of claim 1, wherein the holding means are formed in one piece with the carriage.

6. The marking apparatus of claim 5, wherein the holding means comprise an arm, forming a fork with a body of the carriage.

7. The marking apparatus of claim 1, wherein the or each other guiding member is received in a ring which is fast in translation with the holding means, in the principal direction of the guiding member, while being fast in translation with the guiding member in the transverse direction of the latter.

8. The marking apparatus of claim 7, wherein the ring is housed in a groove made on the surface of the carriage.

9. The marking apparatus of claim 8, wherein the groove opens out on a side of the carriage.
